(19) United States
(12) Patent Application Publication
(10) Pub. No.: US 2018/0103612 A1
(43) Pub. Date: Apr. 19, 2018

(54) SHIN GUARD FOR PETS

(71) Applicant: James Marcinkowski, Suprise, AZ (US)

(72) Inventor: James Marcinkowski, Suprise, AZ (US)

(21) Appl. No.: 15/292,142

(22) Filed: Oct. 13, 2016

(51) Int. Cl. A01K 13/00

(52) U.S. Cl. CPC A01K 13/007

(57) ABSTRACT

A unique protection guard for the protection of an injury is disclosed herein. The protection guard includes protective sheets, fasteners and cushioning. The protection guard may include an optional inner sheet having skin friendly adhesive. The protection guard includes flexible and breathable protective sheet such as, for example, Velcro, which serves to fasten the protection guard to an animal's injured area. Foam padding provides cushioning, such that wear injuries from the protective guard are prevented.

### FIELD

This disclosure relates to a unique device and method for protecting an injury on an animal and more particularly to a shin guard that is easily applied and secure from a pets chewing and licking of the injured area.

### BACKGROUND

The practice of securing and protecting an injured area of a pet has particular challenges that cause normal modes of treatment of human injuries to be largely ineffective for use in veterinary medicine. As such, various protective solutions have been brought to market in an effort to reduce opportunities for further injury due to a pet licking, gnawing, and over-using the injured area. While some of the solutions may be variously effective, they are not typically secure in that a small animal will typically remove any wound application that is with the animal's reach.

Veterinarians have also created and implemented their own techniques for dressing wounds to reduce the damage that can occur to the dressing through normal pet activity. In the case of a leg injury, for example, a veterinary professional may wrap the animal's leg, starting at the animal's chest, continuing past the abdomen, and finally down the length of the injured leg. In other words, a small wound often requires overly extensive bandaging in order to stand up to an animal's attempts to remove it. Such techniques are clearly taxing in terms of time and materials alone, not to mention the added stress that this process can place on an already frightened and injured animal.

To overcome these and other disadvantages, there have been attempts to produce single unit bandaging solutions that can be more quickly and securely applied. For leg injuries in particular, there are several variances of a shin guard type solutions, as outline below.

U.S. patent application Ser. No. 11/595,871 to Eunice Franco shows a sock-like garment that an animal's leg can be slipped into with two straps that join behind the neck (over the shoulders of the animal). This clasp will be unreachable by the animal. This leg and foot cover guard allow the pet owner to properly clean, medicate and cover the wound and then assure that the pet will not remove the bandage and medicine. It is a protective shield.

U.S. patent application Ser. No. U.S. 13/465,390 to Denise Backman & Craig Backman shows a harness that encases the animal's leg from the chest to right above the elbow, which contain elastic strips to allow for stretch around the leg; one strap going from the outside of the leg along the lateral brachium, ending over the withers, with another strap coming up under and around the opposite pectoral area to meet at the withers. A buckle attaches the two straps that is adjustable per girth of the animal's full circumference of their thorax or attached to a well-fitted harness for rear leg bandage harness application.

U.S. patent application Ser. No. U.S. 10/186,894 to Charles Kuntz shows a device which prevents pet's from licking and mutilating a medical appliance which is attached to the patient. The medical appliance may include but is not restricted to a bandage, splints, catheter, fluid administration set, etc. The device comprises a housing containing electronic circuitry powered by two series-connected, replaceable nine volt batteries.

U.S. patent application Ser. No. U.S. 13/677,370 to Ronald Dhing shows a shin guard sleeve for use in holding a soccer shin guard in position adjacent a person's shin includes a sock having a foot portion and a leg portion extending upwardly from the sock portion, the upper portion includes an upper end defining an upper opening that includes an exterior surface.

U.S. patent application Ser. No. U.S. 12/910,153 to Nike, Inc. relate to a shin guard construction having a shin guard and a strap. The strap may provide a number of adjustments, such as adjusting a vertical position of strap attachment to the shin guard, a length of the strap, and/or a position of a portion of the strap in both a horizontal and/or a vertical location on a wearer's leg. Further, the strap may have an upwardly inclined orientation relative to a horizontal plane extending through the shin guard. The orientation of the strap in an upward direction may be a result of a location and/or orientation of one or more fasteners. Additionally, the orientation of the strap may be a result of the size and/or shape of the strap.

None of the above inventions and patents, taken either singly or in combination, is seen to disclose a single unit injury protection guard with fasteners at opposite ends.

### SUMMARY

To address the limitations described above and others, a protection guard (i.e., shin guard) is disclosed for simplifying and better securing a protective covering applied to areas of an animal's leg. The protection guard may include but not limited to a protective sheet, fastener, and shock absorbing materials (e.g., cushioning).

In various embodiments, the protective sheet is constructed of a durable and non-toxic material having a shape and texture that makes pet chewing less effective or desirable. As will be described in greater detail, fasteners are attached at opposing ends of the protective sheet and cushioning is attached to the back side of the protective sheet.

Another aspect of the present invention relates to a shin guard for pets that includes a non-irritating inner sheet, an outer protective sheet, adhesive strips for blocking the movement of the inner and outer sheet, and foam padding to prevent injuries from shin guard.

Another aspect of the invention is to provide a multi-sheet protection guard that includes a non-irritating inner sheet, an outer protective sheet, adhesive strips for blocking the movement of the inner and outer sheet, and foam padding to prevent injuries from shin guard.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

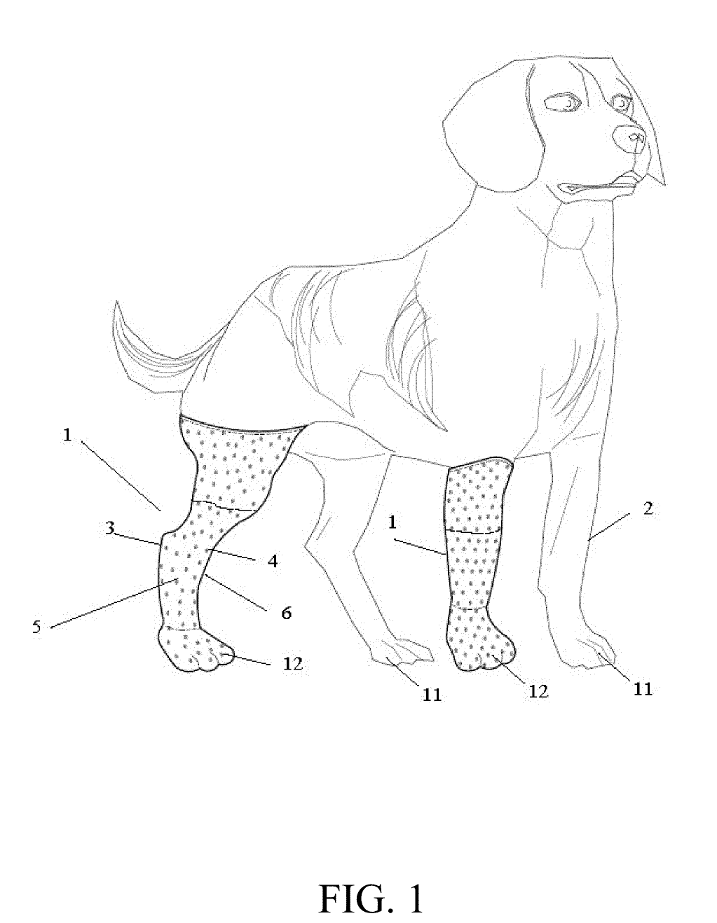

FIG. 1 shows a front view of an embodiment of a protection guard according to the present invention; and

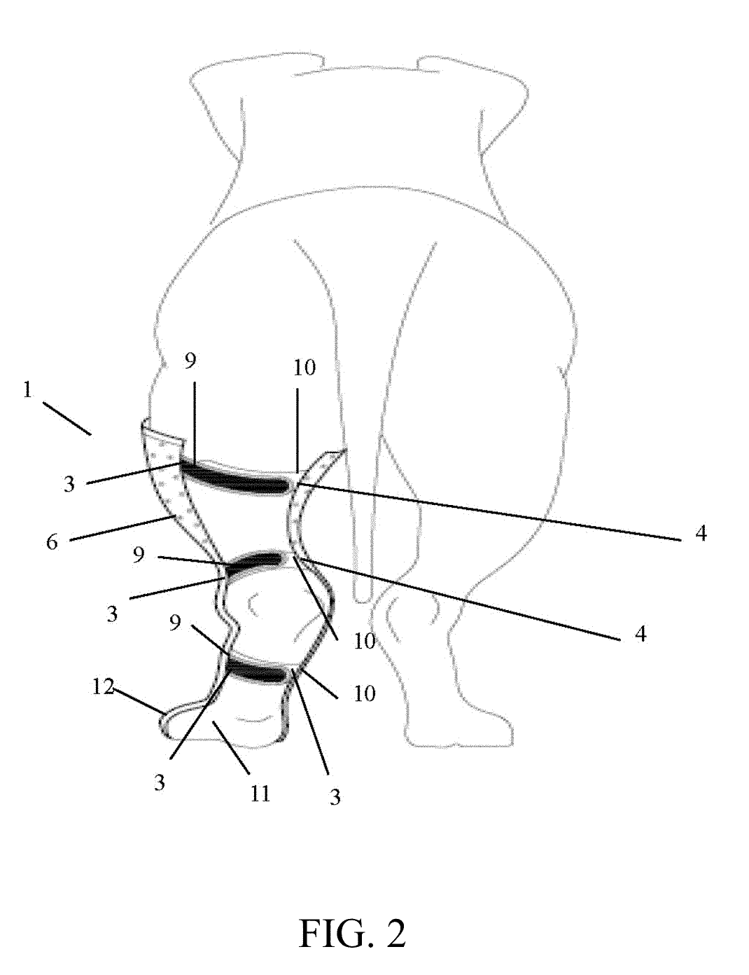

FIG. 2 shows a front view of an embodiment of a protection guard with fasteners according to the present invention.

### DETAILED DESCRIPTION

The detailed description of various embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems and methods are described relative to the corresponding figures. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As shown in FIG. 1, a protection guard 1 is shown, which is adapted to wrap around the leg 2 of pet (e.g. dog, cat, etc.) and secured by fasteners 09 & 10 (as shown in FIG. 2). Further, the protection guard 1 includes a protective sheet 06 that defines opposing ends 03 & 04. Moreover, the protective sheet 06 includes breathable holes 05 that are located on protective sheet. Also, the disclosed protection guard 1 includes a paw boot 12 which adapted for wear over the paw 11 of the pet.

As shown in FIG. 2, the fasteners 09 & 10 are attached to the protective sheet 06 at opposite ends 03 & 04 for securely fastening the opposing end 03 & 04. The protection guard 1 includes a cushioning (not shown), which is attached to the back side of the protective sheet 06 to prevent injuries.

The present invention generally provides a protection guard 1 including but not limited to protective sheet 06, fasteners 09 & 10 and cushioning. In general, the protective sheet 06 is manufactured of one or more sheets that include an upper sheet, inner sheet, and adhesive sheets for combining the upper and inner sheet, wherein all sheets are non-chewable breathable and flexible in nature. In one embodiment, the protection guard includes one or more fasteners 09 & 10, which are attached at the opposing sites 03 & 04 of the protective sheets 06 for blocking moment of the protection guard to prevent injury to legs 2. Cushioning (not shown) of the protective sheet 06 prevents injuries from the protection guard.

In an embodiment, the protection guard 1 comprising a protective sheet 06 of non-chewable plastic crafted with breathable holes 05 for proper aeration. fastener 09 & 10 attached at the opposite ends 03 & 04 of the known by the trademark VELCRO and foam pads as cushioning attached at the back side of the protective sheet 06.

In another embodiment, protection guards 1 comprising a multi-sheet protective sheet 06 of non-chewable material further includes an upper sheet, inner sheet, and adhesive sheet for combining the upper and inner sheet. In this embodiment, fastener 09 & 10 attached at the opposite ends 03 & 04 of the known by the trademark VELCRO.

In yet another embodiment, the protection guard includes a multi-sheet protective sheet 06 comprising an upper sheet, inner sheet and adhesive sheet for combining the upper and inner sheet, wherein the upper sheet is made of breathable plastic such as, for example, PETE, HDPE, PVC, LDPE, PP, PS, etc.

In various embodiments, the protection guard includes of a multi-sheet protective sheet 06 comprising an upper sheet, inner sheet, and adhesive sheet for combining the upper and inner sheet. The upper sheet may include a reflective or illuminated material, which increases the pet's visibility at night. Accordingly, fastening laces attach at opposing ends 03 & 04 and foam pad cushioning is attached to the protective sheet 06. The inner sheet may have added thickness, sufficient to act as additional cushioning for preventing injuries from protection guard. The reflective material may include, for example, reflective paints, synthetic films, metallic foils, Scotchlite, and the like.

It is to be understood that the above description is intended to be illustrative, and not restrictive. For example, the above-discussed embodiments may be used in combination with each other. Many other embodiments will be apparent to those of skill in the art upon reviewing the above description.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.”

Where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A protection guard comprising:
a) at least one protective sheet;
b) at least one fastener; and
c) a plurality of cushioning on the protective sheet.

2. The protection guard according to claim 1, wherein the protective sheet is made of non-chewable material.

3. The protection guard according to claim 2, wherein the non-chewable material is selected from the group of PETE, HDPE, PVC, LDPE, PP, PS and combination thereof.

4. The protection guard according to claim 1, wherein the protective sheet is breathable.

5. The protection guard according to claim 1, wherein the protective sheet is made of non-toxic material.

6. The protection guard according to claim 1, wherein the protective sheet is flexible. The protection guard according to claim 1, wherein the fastener is nonmetallic.

8. The protection guard according to claim 1, wherein the fastener is flexible.

9. The protection guard according to claim 1, wherein the fasteners are attached to the opposite ends of the protective sheet.

10. The protection guard according to claim 1, wherein the fastener is Velcro.

11. The protection guard according to claim 1, wherein the cushioning is located at the opposite ends of the protective sheet.

12. The protection guard according to claim 1, wherein the cushioning is made of Foam.

13. The protection guard according to claim 1, further comprising of inner sheet.

14. The protection guard according to claim 1, wherein the inner sheet is breathable.
